(19) United States
(12) Patent Application Publication
(10) Pub. No.: US 2004/0168728 A1
(43) Pub. Date: Sep. 2, 2004

(54) Device for receiving and discharging liquid substances

(76) Inventors: Andreas Schober, Schwangau (DE); Gregor Schlingloff, Klein-Gerau (DE); Jens Albert, Zeitz (DE); Thomas Henkel, Jena (DE); Gunter Mayer, Jena (DE)

Correspondence Address: Jordan & Hamburg, 122 East 42nd Street, New York, NY, 10168, US

(21) Appl. No.: 10/450,979

(22) PCT Filed: Dec. 18, 2001
(86) PCT No.: PCT/EP01/14953

(30) Foreign Application Priority Data
Dec. 18, 2000 (DE) 100637337

(51) Int. Cl. F17D 1/08

(52) U.S. Cl. 137/561 R

(57) ABSTRACT

The invention relates to a device for controlling the amount of liquid substances received and discharged. It is an object of the invention to produce a device, enabling a plurality of different liquid substances to be received and discharged from micro or nano titer plates. According to the invention, it is possible to carry out one or more chemical or biological reactions in said device and to receive liquid substances with differing viscosity, as a result of capillary channels which are arranged at an equal distance from each other and are provided in a row, said channels being brought together in a communicative link with a chamber which is can be impinged upon by overpressure and underpressure, whereby the capillary channels are embedded in the plate and one sieve-type membrane is associated with the ends of the capillary channels at least on the inner side of the pressure chamber. According to the invention, an area is provided above each end of the capillary channels for receiving a liquid substance. Said areas are arranged separately from each other and are disposed inside the chamber which can be impinged upon by high and low pressure.

### BACKGROUND OF THE INVENTION

The present invention relates to a device for controlling the amount of liquid substances received and discharged, preferably for the amount of said substances received and discharged from micro and nano titer plates, respectively, whereby optimally all cavities of at least one row of the titer plate can be registered simultaneously.

In the macroscopic range suction pipettes are known for receiving larger volumes, whereby said pipettes being arranged at an equal distance from each other in the form of a rake are jointly combined with a balloon, a flask or a similar component that can be impinged upon by overpressure and underpressure. Due to this construction, this system allows to receive a liquid substance from several adjacent vessels.

A reactor for microchemical and/or microbiological reactions comprising a pipette with a dispenser is also known (DE 196 42 77 A1), whereby a reactive solid phase substrate with at least one immobilized reaction partner is provided near the lower, narrowed end of the pipette. For mechanical reasons such constructions as well as the ones described in DE 197 23 469 A1 cannot be reduced to any minimized dimension and are not part of the present invention.

Preferably, the inner and outer surfaces should be of hydrophobic or solvent-repellent quality which can be achieved by applying chemical coating or physical structuring processes or combinations of both (e.g. a self-cleaning surface).

### SUMMARY OF THE INVENTION

It is an object of the invention to produce a device which enables a plurality of even different liquid substances to be received from micro or nano titer plates and to be discharged in the same raster again, if required in some defined subset volumes, and to offer the possibility to carry out one or more chemical or biological reactions in said device and to receive liquid substances of different viscosity simultaneously.

The object is comprised in the characterizing attributes of the first claim. Advantageous kinds of design are included in the following claims.

The invention is based on the principle that at least in one row capillary channels are arranged at an equal distance from each other and are brought together in a communicative link with a chamber which can be impinged upon by overpressure or underpressure, whereby the capillary channels are embedded in a plate and one sieve-type membrane is associated with the ends of the capillary channels at least on the inner side of the pressure chamber. According to the invention, an area is provided above each end of the capillary channels for receiving a liquid substance, whereby in said areas chemical or biological reactions can be performed. The areas are arranged separately from each other and are disposed inside the chamber which can be impinged upon by overpressure or underpressure, whereby said capillary channels are designed in such a way that their interior volume is smaller than the volume capacity of the area assigned to each capillary.

The present invention enables a high-parallel transfer of liquids and the discharge of substances, in particular the one from micro or nano titer plates of any design or from similar receptacles.

The device recommended can be used both for solid phase coupled syntheses and for liquid phase syntheses in any version. The decisive advantage of this device is given by the fact that defined volumes of differing viscosity can be received and discharged simultaneously, whereby a highly-parallel and efficient transfer of liquids is ensured.

Most of all, this device allows to carry out transfer operations for applications in the field of bioassays efficiently, e.g. dilution rows of library substances in assays.

In this way, among other processes it is also possible to realize bioassays after washing procedures, after the addition of the target substance to the solution and after the photo-separation of the synthesized library substances. Another possible application is the discharge of substances for further analyzing processes by transferring them into vessels suited for analyzing methods. The integration of bioassay and synthesis being possible by using this device also allows a software-aided evaluation.

### DETAILED DESCRIPTION OF THE INVENTION

The present invention will now be described in more detail by way of the following schematic example. The figures show:

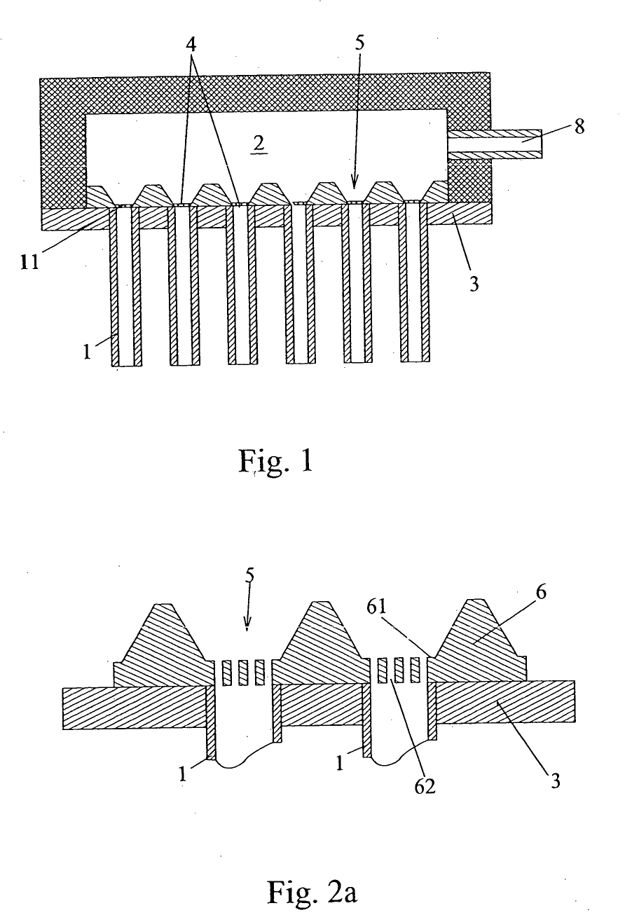

FIG. 1 a possible design of the device for receiving and discharging liquid substances in longitudinal section,

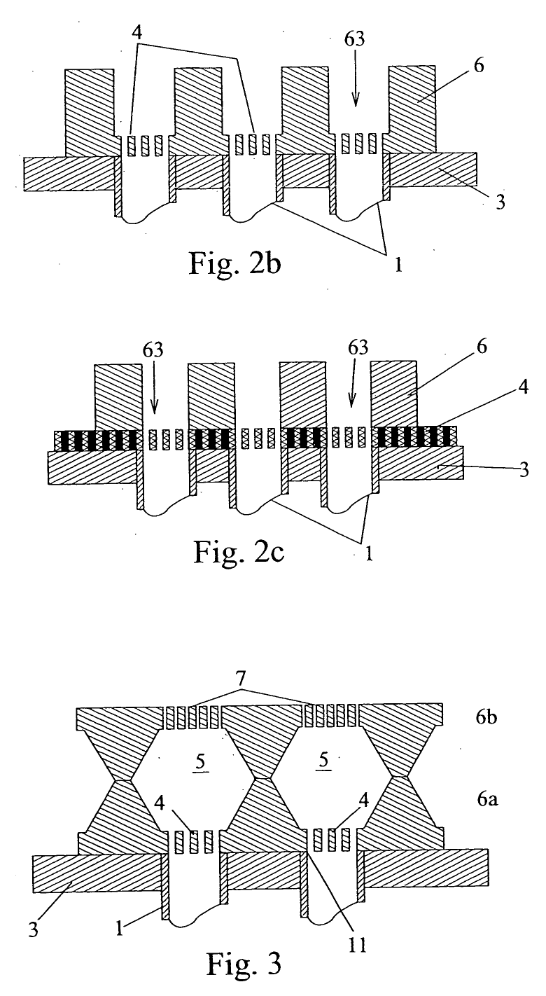

FIG. 2a a first possible design of parts of the device being important for the present invention,

FIG. 2b a second possible design of parts of the device being important for the present invention,

FIG. 2c a third possible design of parts of the device being important for the present invention,

FIG. 3 a preferred design of the device with the creation of areas with a defined volume where reactions can be carried out, and

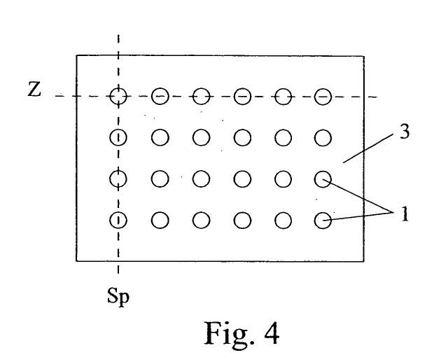

FIG. 4 as an example, a view of the bottom of the device which is provided with capillaries in several rows and columns, whereby the distance of these capillaries from each other corresponds to the cavity raster of a given titer plate.

### DESCRIPTION OF THE PREFERRED EMBODIMENTS

FIG. 1 shows the scheme of a possible design of the device presented in longitudinal section. In this device, capillary channels 1 are arranged at an equal distance from each other and are provided in a row. Said channels are brought together in a communicative link with a chamber 2 which can be impinged upon by overpressure or underpressure via a connecting piece 8, whereby the capillary channels 1, which are particularly formed as steel cannulas, are embedded in a plate and fixed by pasting. At least the ends of the capillary channels 11 inside the pressure chamber, which are flush with the level of the pressure chamber of the plate 3 in the example, are first associated with a sieve-like membrane 4 above which an area 5 is provided for each end of the capillary channels for receiving a liquid substance. Said areas 5 are arranged separately from each other and are jointly disposed inside the chamber 2 which can be impinged upon by overpressure and underpressure. This arrangement ensures that all capillary channels 1 can be impinged upon by an identical pressure. According to the type of design, i.e. according to the dimensions of the perforations in the sieve-type membranes 4, the example shown in FIG. 1 allows to draw a volume predefined in the appropriate capillary channel into the areas 5 at a sufficient underpressure, or, depending on the surface tension of the liquid substances used, it is also possible that only the capillary channels 1 are charged with any predefined volume up to the membrane 4, if the perforation of the sieve-type membranes 4 is sufficiently small, because in this case the membranes 4 prevent the penetration of the liquid substances. In the last case mentioned, a defined volume of the liquid substances is again received, but this case offers the advantage that substances of differing viscosity can be received simultaneously by one device.

In the example, each area 5 receives a volume of between 10 nl and 2 μl, if it is to be used as a reaction area. The capillaries associated shall have a volume of between 1 nl and 120 nl. Depending on the actual conditions, the said volumes can also have other values. But it is to ensure that if reactions are to be carried out in the areas 5, said areas 5 have a larger volume than the capillary channels associated with them to prevent the reaction liquids from overflowing between the areas 5.

FIG. 2a shows a first possible kind of design of invention-important parts of the device presented in FIG. 1. In this example, said areas 5 and the sieve-type membranes 4 are formed by one-piece component 6 provided with several cavities to first bottom parts 61, whereas the remaining bottom parts are provided with a perforation 62.

FIG. 2b shows a second possible kind of design of invention-important parts of the device presented in FIG. 1. In this example, the areas 5 are formed by one component 6 which is provided first with several through-hole cavities 63 which on their part are coated with separate sieve-type membranes 4 on the side facing the capillary channels 1.

And FIG. 2c demonstrates a third possible kind of design of invention-important parts of the device presented in FIG. 1. In this example, the sieve-type membrane 4 is formed by a continuous membrane which comprises all cavities 63 together. This membrane is a net-like one that is pasted between the plate 3 and the component 6.

FIG. 3 shows a preferred design of the device being characterized by the creation of areas 5 of a defined volume where reactions can be performed. For this type of design two one-piece silicon or glass wafers 6a and 6b are used and provided with cavities which are positioned exactly opposite one to the other and reach to the bottom part, and each of the remaining bottom parts is provided with sieve-type membranes 4; 7 being manufactured by selective etching, a well-known process which is not to be explained here in detail. The wafers 6a and 6b manufactured in this way are combined with each other by anodic bonding, pasting or other joining techniques at the face opposite to the sieve-type membranes 4; 7. Since said techniques are also common methods, a detailed explanation is superfluous in this context.

Other techniques for manufacturing the kinds of wafers 6a, 6b described above such as PE formed structures which also allow the use of sieves with perforations between 0,5 μm and 35 μm and chamber dimensions of the reaction areas 5 of between 10 nl and 8 μl are also part of the present invention.

A significant aspect of the example just described is the fact that the area 5 provided above each end of the capillary channels and formed by the two wafers 6a and 6b is closed by a second gas-transmissible sieve-type membrane 7 at the side facing the pressure chamber 2 (not shown in FIG. 3), whereby the perforations of this second membrane 7 are smaller than the ones of the sieve-type membrane 4 associated with the end of the capillary channel 11 inside the pressure chamber, and depending on the surface tension of the liquid substances to be used and on the value of the underpressure applied said perforations are as small as to prevent the liquid substances from penetrating the second sieve-type membrane 7. In the example, the sieve-type membrane 4 has a perforation width of 10 μm and the perforation width of the membrane 7 is 1 μm. The corresponding areas 5 in each of which a reaction is to be performed have a volume of 1 μl and the capillary channels 1 have a capacity of 100 nl in the example given.

The liquid reaction can be performed for example in the following way: Five different dissolved reagents are received one after the other by the device due to an appropriately set underpressure and are drawn through the sieve 4 located at the side of the capillary. Thus, the volume is kept in the reaction area. During this process, each new volume received is mixed with the one already existing in the reaction area. The fine-porous membrane 7 prevents the penetration of the liquid into the chamber 2. Depending on the materials used for the device, it is also possible to carry out reactions at increased temperatures.

For the present invention the chamber 2 which can be impinged upon by underpressure or overpressure can also be designed in such a way that it can be demounted from the plate 3 (as implied in FIG. 1) or that it can be opened at least above the cavities 63 (not shown in detail) to create a second possible access to the areas 5. In this way in the designs according to FIGS. 1 and 2a to 2c, the areas 5 can be filled with an agent from above, if required by means of a second device being designed in the same way as the device described. Moreover, it is possible that the areas 5 are flooded to an even level, if the opening option design has been selected for the chamber 2.

If sieve-type membranes are mentioned within the context of the special description given above, said membranes do also comprise structures with irregularly distributed openings or through-holes, such as frits, if they fulfill the same functions as the sieve-type membranes do. In an extreme case, the function of said membranes can also be taken over by a sufficiently tiny hole. This construction, however, does not present a preferred kind of design.

For the present invention an advantage is given, if the walls of the areas 5, at least the inner sides of the walls of the capillary channels 1 and the surfaces of the sieve-type membranes 4; 7 are provided with a hydrophobic surface and/or a self-cleaning physical microstructure (Lotus effect) or a solvent-repellent detergent. These measures facilitate the cleaning of the device.

Finally, FIG. 4 shows a bottom view of the device as an example, whereby multiple capillary channels 1 are embedded in the plate 3. Said capillary channels are arranged at an equal distance from each other in rows Z and columns Sp in a matrix pattern corresponding to the cavity distribution of a given titer plate not shown here. Each of the capillary channels is associated with an area 5 for receiving a liquid substance, whereby said areas are not shown in FIG. 4.

### LIST OF REFERENCE NUMERALS

1—capillary channel

11—ends of the capillary channels

2—(pressure) chamber

3—plate

4, 7—sieve-type membranes

5—(reaction) area

6—one-piece component

61—bottom part of the component 6

62—perforation in the bottom part 61

63—through-hole cavities

8—connecting piece

Z—rows

Sp—columns

1. A device for receiving and discharging liquid substances, whereby at least in one row capillary channels (1) are arranged at an equal distance from each other and are brought together in a communication link with a chamber (2) which can be impinged upon by overpressure or underpressure, wherein the capillary channels (1) are embedded in a plate (3) and one sieve-type membrane (4) is associated with the ends of the capillary channels (11) at least inside the pressure chamber, an area (5) is provided above each end of the capillary channels for receiving a liquid substance, whereby said areas (5) are arranged separately from each other and all areas (5) are commonly disposed in the chamber (2) which can be impinged upon by overpressure or underpressure.

2. A device according to claim 1, wherein said areas (5) and the sieve-type membranes (4) are formed by a one-piece component (6) being provided with several cavities to first bottom parts (61), whereas the remaining bottom parts are provided with a perforation (62).

3. A device according to claim 1, wherein said areas (5) are formed by one component (6) which is provided with several through-hole cavities (63) which are associated with a sieve-type membrane (4) on the side facing the capillary channels (1).

4. A device according to claim 3, wherein the sieve-type membrane (4) is formed by one continuous membrane which covers all cavities (63) together.

5. A device according to claim 2, wherein the one-piece component (6) is formed by a silicon or glass wafer provided with cavities to the first bottom parts, whereas the remaining bottom parts are provided with the sieve-type membranes (4) by selective etching.

6. A device according to claim 1, wherein the area (5) provided above each end of the capillary channels is closed by a second, gas-transmissible sieve-type membrane (7) on the side facing the pressure chamber (2), whereby the perforations of said second membrane (7), are smaller than the ones of the sieve-type membrane (4) associated with the ends of the capillary channel (11) inside the pressure chamber, and depending on the surface tension of the liquid substances to be used and on the value of the underpressure applied, said perforations are designed as small as to prevent the liquid substances from penetrating the second sieve-type membrane (7).

7. A device according to claim 6, wherein said areas (5) are formed by two one-piece silicon or glass wafers (6a, 6b) being provided with cavities which are positioned exactly opposite one to the other and reach to the bottom part, and the sieve-type membranes (4, 7) are provided in the remaining bottom parts by selective etching, whereby said wafers are combined with each other by anodic bonding, pasting or other joining techniques at the face opposite to the sieve-type membranes (4, 7).

8. A device according to claim 1, wherein the chamber (2) which can be impinged upon by underpressure or overpressure is designed in such a way that it can be demounted from the plate (3) or it can be opened at least above the cavities (63) to create a second possible access to the areas (5).

9. A device according to claim 1, wherein the walls of the areas (5) and of the capillary channels (1) and the surfaces of the sieve-type membranes (4, 7) are provided with a hydrophobic surface and/or a self-cleaning physical microstructure (Lotus effect) or a solvent-repellent detergent.

10. A device according to claim 1, wherein the capillary channels (1) are formed by steel cannulas fixed into the plate (3) by pasting.

11. A device according to claim 1, wherein multiple capillary channels (1) being embedded in the plate (3) are arranged at an equal distance from each other in rows (Z) and columns (Sp) in a matrix pattern corresponding to the cavity distribution of a given titer plate, whereby each of the capillary channels (1) is associated with one area (5) for receiving a liquid substance.

12. A device according to claim 1, wherein each capillary channel (1) is designed in such a way that its interior volume is smaller than the volume that can be received by the area (5) associated with it.
